(19) United States
(12) Patent Application Publication
(10) Pub. No.: US 2009/0013814 A1
(43) Pub. Date: Jan. 15, 2009

(54) TRANSMISSION ELEMENT AND MECHANICAL COUPLING GEAR AS WELL AS A MECHANICAL GEAR SHIFT FOR A MOTOR VEHICLE TRANSMISSION

(75) Inventor: Axel GEIBERGER, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/129,206

(22) Filed: May 29, 2008

(30) Foreign Application Priority Data
May 27, 2007 (DE) 102007041289.6

(51) Int. Cl. G05G 1/00

(52) U.S. Cl. 74/470

(57) ABSTRACT

Transmission element, coupling gear as well as mechanical gear shift for motor vehicle transmission with a transmission element for a mechanical coupling gear with a pipe section shaped outer ring and within the outer ring an axis parallel oriented inner ring a good adjustability to individual requirements is achieved with the possibility to realize force/path characteristics by the fact that between the inner ring and the outer ring several pipe section shaped compression bodies are located.

### CROSS-REFERENCE TO RELATED APPLICATION

This application claims priority to German Patent Application No. 102007041289.6, filed May 29, 2007, which is incorporated herein by reference in its entirety.

### TECHNICAL FIELD

The present invention generally relates to mechanical engineering and more particularly relates to a transmission element and mechanical coupling gear as well as a mechanical gear shift for a motor vehicle transmission.

### BACKGROUND

Various transmission elements or coupling elements for the transmission of forces and/or movements are well known. By means of such transmission elements, either motive forces or brake forces or also operation movements are transferred.

For this purpose, gear systems, linkage systems or traction systems are used. Often, it is necessary to transfer certain movements, particularly translational movements and, in doing so, to decouple other movements from other time characteristics, vibrations, for example. For this purpose, mechanical decoupling- and/or damping elements are already known in various forms.

From DE 10 2005 037597, for example, a transmission element is known which is appropriate for the operation of a motor vehicle. A partially elastic, partially damping element, a combination of an inner ring and an outer ring in a coaxial arrangement, connected with a conic-section shaped bridge which runs between these are described in this document.

The transmission element has a elastomer synthetic material and the inner ring as well as the outer ring are each connected with a connection orifice, in order to transfer a force decoupled from an active vibration.

Because of the truncated cone-shape of the structure of the bridge in the transmission element, a force component in the axial direction of the inner ring and/or outer ring arises when there is a stress/load. This is generally not desirable.

From EP 1 679 444 A2, a further development of a similar transmission element is described in which two concentric coaxial rings made from an elastomer material. There, the rings are connected by individual bridges distributed around their girths, and the bridges are provided alternately on the lower and upper ends of the double ring configuration, in order to create a symmetry that would hinder the occurrence of axial forces in the case of stress.

In view of the foregoing, at least one object is to create a transmission element that transmits a force as reliably as possible and without the occurrence of unwanted force components, with a realization of desired force transmission characteristics through minimal changes in form. In addition, other objects, desirable features, and characteristics will become apparent from the subsequent summary, detailed description, and the appended claims, taken in conjunction with the accompanying drawings and this background.

### SUMMARY

The at least one object, other objects, desirable features and characteristics are provided according to an embodiment of a transmission element for a mechanical gear coupling with a pipe section shaped outer ring and, within the outer ring, and axial parallel with it, a pipe section shaped inner ring, characterized in that between the inner ring and the outer ring several pipe section shaped compression bodies are arranged. A Mechanical gearshift for motor vehicle, which has a transmission with at least one pull for connecting the gear lever with the gears, is also provided in accordance with an embodiment of the present invention. The mechanical gear shift having a pipe section shaped outer ring and, within the outer ring, and axial parallel with it, a pipe section shaped inner ring, characterized in that between the inner ring and the outer ring several pipe section shaped compression bodies are arranged.

At least one object is that the desired damping or decoupling or force transmission characteristic can be realized using a transmission element with an inner ring and an outer ring which is coaxial with it, as known from the current state of technology, if pipe section shaped bodies are used as the damping elements between the inner ring and the outer ring. These are elastically malleable in a lateral direction, that is perpendicularly to the orientation of each pipe section, in the shaping of the wall thickness where the characteristics of the materials are taken into account, wherein through the choice of material, the degree of damping can be determined and the path of the elasticity curve can adjusted, when the force of the transmission element is transmitted variably, through the size and wall thickness as well as the number of the corresponding pipe section-shaped compression bodies. Through this, linear force/path diagrams as well as sectioned non-linear diagrams, each according to the shaping of the compression bodies are realized as characteristics of the transmission element.

In this way, the configuration according to an embodiment of the invention allows the adjustment of the transmission element to the established mechanical transmission instruction through minimal means. As a result, an optimal damping or vibration decoupling can be achieved.

Particularly constructively simple to handle and produce as well as for incorporating in a force transmission path through installation with corresponding mountings is the inner and/or outer ring that is an annular shape in cross section.

However, depending on the characteristic and the manufacturing method available as well as installation requirements, an inner and/or outer ring which is elliptical in cross section may also make sense. Therefore, it is also possible, for example, for one of the rings to be annular shape, the other elliptical in cross section.

In principle, embodiments of the corresponding inner and/or outer ring pipe sections that are rectangular in cross section are also possible.

Advantageously, the compression bodies comprise an annular or elliptical cross section, making them easy to produce and their mechanical characteristics easy to determine and to adjust.

In an advantageous embodiment of the invention, the compression bodies are positioned on the inner ring and/or outer ring when the transmission element is relaxed. In this way, the individual elements of the transmission element can work together without backlash.

The compression bodies can be connected with the inner and/or outer ring. This produces cohesion within the transmission element, which enhances its reliability and makes its behavior easy to predict because the compression bodies are thereby fixed in one location.

An even more advantageous embodiment of the invention can be provided where the compression bodies are integrally formed with the inner and/or outer ring. That way the transmission element has no parts that move in opposition to one another and it is correspondingly easy and reliable in terms of maintenance, in terms of assembly, when the transmission element forms a kinematic chain with other parts.

The adjustable force characteristic is particularly advantageous, in the same way as with the production of the transmission element, when the compression bodies are configured axis parallel to the inner and outer rings.

An advantageous embodiment with respect to function and to the ease of manufacture is one where the contours of the inner ring and outer ring on the one hand, and those of the compression bodies on the other hand, intersect. Equally advantageous, the entire thickness of the wall of at least one of the compression bodies where it is in contact with the inner ring and/or the outer ring is contained within the wall of the inner ring and/or outer ring. These embodiments have advantages especially when the inner ring, the outer ring, and the compression bodies form a homogeneous entity, particularly combined into one piece through die casting, or manufactured technically from a homogeneous block, for example through machining operations. As a result, the transmission element can be manufactured from a homogeneous block, for example, through blanking or cutting.

Instead of die-casting, another forming procedure such as pressing or sintering, for example, can be used; this can be done when Polytetrafluorethylen is used, for example.

Advantageously the inner ring and/or the outer ring can be made from an elastic plastic material, particularly from an elastomer. For that purpose, dense rubber or a compressible material, such as foam rubber, come to mind.

The embodiments of the invention provide, besides a transmission element, a coupling gear with such a transmission element, wherein additionally a first connector element collected to the outer ring, and a second connector element connected to the inner ring are provided. The first and second connector elements may, for example, be in the shape of a metal bush, which is compressed or glued to the inner ring or the outer ring, or firmly fixed to these by other means. The first connector element, which is connected to the outer ring, can be, for instance, through a process of soldering or welding, or also by riveting or bolting, connected with a linkage system or a movable pull, such as a control cable. The second connector element can for example take on a bolt nut, which enforces this and forms a kinematic chain with other parts.

The embodiments of the invention also provide a mechanical gear shift for a motor vehicle transmission with at least one pull to connect a gear lever with the gears, and one coupling gear with a transmission element is provided according to an embodiment of the invention. The coupling gears serves as the coupling of the gearshift lever in the motor vehicle in this specific case; it is manually operated through the means of at least one pull with the transmission. The pull can, for example, be realized through a linkage system or a cable-like element. Through the transmission element, or the coupling gear, the vibrations which come from the combustion engine and are at least partially transferred to the transmission are decoupled from the gear shift lever, partially damped and are therefore not at all or at least minimally discernible by the driver who operates the gear shift lever.

Through the specific shaping of the transmission element, different characteristics are optimally adjustable according to specific requirements because of the choice of size and wall thickness as well as the compression bodies and the inner and outer rings.

### BRIEF DESCRIPTION OF THE DRAWINGS

The present invention will hereinafter be described in conjunction with the following drawing figures, wherein like numerals denote like elements, and

FIG. 1 illustrates various force/path characteristics, which are adjustable to the transmission element according to an embodiment of the invention;

FIG. 2 is a three-dimensional view of the transmission element;

FIG. 3 is a top axial view of the transmission element according to FIG. 2;

FIG. 4 is a top axial view of a transmission element in a further embodiment; and

FIG. 5 is a top axial view of a transmission element in a third embodiment.

### DETAILED DESCRIPTION

The following detailed description is merely exemplary in nature and is not intended to limit application and uses. Furthermore, there is no intention to be bound by any theory presented in the preceding summary and background or the following detailed description.

FIG. 1 shows a diagram in which a deformation path of a transmission element is assigned on the y-axis in the direction of arrow 2 and in which the corresponding force which caused the deformation is on the x-axis indicated by arrow 1.

In a first graph 3, a typical linear characteristic is shown through which the deformation path is approximately proportional with the exception of a hysteresis which distinguishes the characteristics through compression from the characteristics through the alleviation of tension and which is determined by hysteretic memory effects.

In many cases a non-linear transmission characteristic curve makes more sense, when, for example, shocks or vibrations need to be absorbed or damped. Corresponding damping effects are also partially represented through hysteresis in the curve. Such a non-linear graph is marked 4 in FIG. 1.

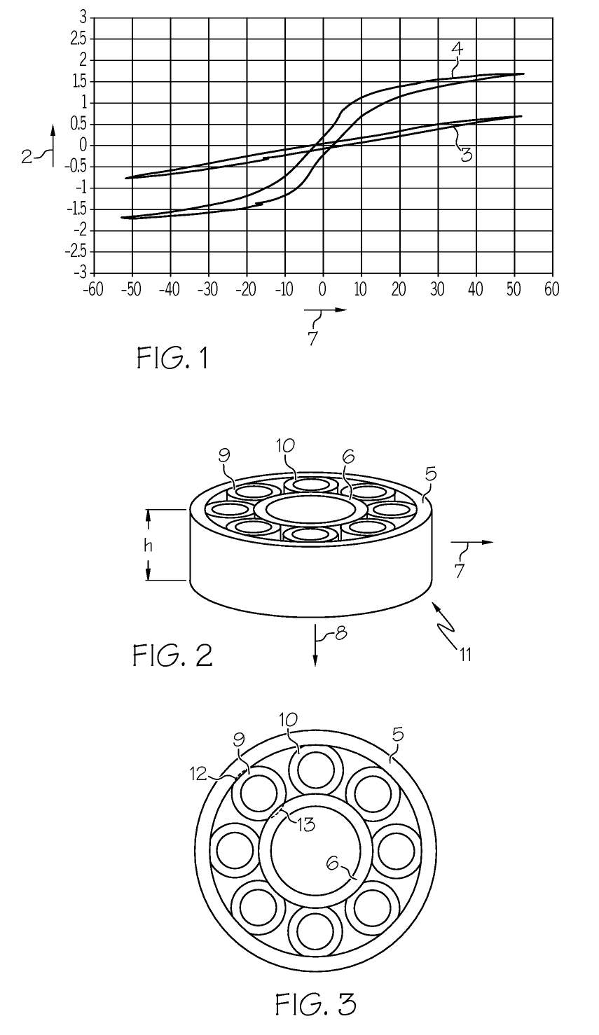

FIG. 2 displays a three-dimensional view of a typical transmission element according to an embodiment of the invention, which has an outer ring 5 or a corresponding pipe section with a circular cross section and an inner ring 6, coaxial and in the displayed case also concentric to the outer ring. The outer and inner rings, due to the symmetrical configuration and in case of a strain in a radial direction as is indicated by arrow 7, allows minimal and preferably no axial movements or forces in the direction of arrow 8; the same level h as well as the compression bodies 9, 10 configured between them which also has a circular form in the cross section and all pipe sections seal with the ends. The compression bodies are equally spaced all round between the inner ring 6 and the outer ring 5 and fixed firmly to both rings. Therefore, eight compression bodies are provided.

The complete transmission element 11 is made of one piece of rubber by means of a vulcanization process. However, it would also be possible to manufacture it from a solid cylindrical form of an appropriate material through milling or cutting. Extrusion molding is another conceivable method of manufacture.

FIG. 3 displays the transmission element again in a top view, and there it is clear that the contours of the compression bodies 9,10 partly, shown by dashed lines 12, 13, run within the outer ring 5 or inner ring 6 walls. If formed integrally, this kind of arrangement is especially simple to accomplish.

The transmission element 11 can be made of, besides elastomers such as rubber, foam rubber or similar, PTFE or other if possible elastic malleable plastic. In high load situations, even spring steel is conceivable.

Through the appropriate choice of wall strength for the compression bodies 9, 10 and for the inner ring and the outer ring, and through the choice of the ratios a desired force/path characteristic can be established.

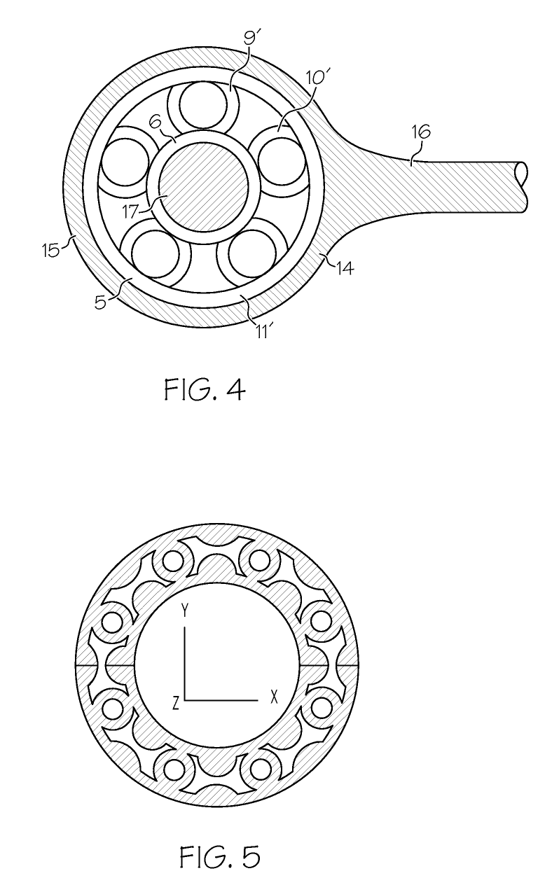

FIG. 4 displays a mechanical gear coupling according to an embodiment of the invention with a transmission element 11′, which comprises an outer ring 5, an inner ring 6, and five compression bodies 9′, 10′ arranged between these.

The compression bodies 9′, 10′ are arranged so that their entire wall thickness at the areas of contact with the inner ring and the outer ring is encompassed within the walls of those. Through this, among other things, a saving in material is also accomplished.

In addition, FIG. 4 displays a first connector element 14, which comprises a bush 15 and a connecting piece 16, which is connected with the bush 15 firmly and in one piece. The connecting piece 16 runs along a linkage system, which is connected directly to the motor vehicle transmission by means of a gearshift cable with a gear lever.

Within the inner ring 6 a Bolt nut 17 is provided, which can, under elastic expansion of the inner ring 6, pressed into this, and by means of a linkage system, not displayed, connected to the motor vehicle transmission.

Instead of the Bolt nut 17 a hollow bush can be employed, in which a bolt nut may be compressed. Alternatively, the bush may be fixed to a bearing shell when the connection to the transmission is developed as a ball pivot. The first and second connector element is typically made of steel, in order to take the appropriate force to be transmitted.

FIG. 5 displays a transmission element with reinforcements on the inner and outer rings facing each other. These reinforcements may also be provided for one of the rings only. The reinforcements can be developed as bars in the axial direction, which cover the full axial length, or only part of the length, of the transmission element. The reinforcements are preferably arranged in between compression bodies, and may have a rounded shape in cross-section. They may be constructed solid or hollow. A further variant has reinforcements that are triangular in cross-section. The reinforcements are preferably formed integrally with the inner and/or outer ring. They can be in directly opposite positions along their respective walls, so that they come in contact on higher load and thereby strengthen the transmission element.

In conclusion, the embodiments of the invention can be used to realize a transmission element or a coupling gear, with whose help, particularly in a motor vehicle, a comfortable manual gear changing is enabled, without disturbing vibrations or noises generated by these to be generated in the passenger interior or to be transferred there. The construction according to an embodiment of the invention lends itself particularly easily to be adapted to individual requirements.

While at least one exemplary embodiment has been presented in the foregoing detailed description, it should be appreciated that a vast number of variations exist. It should also be appreciated that the exemplary embodiment or exemplary embodiments are only examples, and are not intended to limit scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A transmission element for a mechanical gear coupling, comprising:
a pipe section shaped outer ring;
a pipe section shaped inner ring within the pipe section shaped outer ring and axial parallel with the pipe section shaped outer ring; and
a plurality of pipe section shaped compression bodies arranged between the pipe section shaped inner ring and the pipe section shaped outer ring.

2. The transmission element according to claim 1 wherein the pipe section shaped inner ring comprises an annular cross section.

3. The transmission element according to claim 1 wherein the pipe section shaped outer ring comprises an elliptic cross section.

4. The transmission element according to claim 1 wherein the plurality of pipe section shaped compression bodies comprise an annular shaped cross section.

5. The transmission element according to claim 1 wherein the plurality of pipe section shaped compression bodies comprise an elliptic shaped cross section

6. The transmission element according to claim 1 wherein the plurality of pipe section shaped compression bodies are in a loose arrangement along the pipe section shaped inner ring.

7. The transmission element according to claim 6 wherein the plurality of pipe section shaped compression bodies are firmly fixed to at least one of the pipe section shaped inner ring and the pipe section shaped outer ring.

8. The transmission element according to claim 6 wherein the plurality of pipe section shaped compression bodies are incorporated as one piece with at least one of the pipe section shaped inner ring and the pipe section shaped outer ring.

9. The transmission element according to claim 4 wherein the plurality of pipe section shaped compression bodies are in an axially parallel arrangement to the pipe section shaped inner ring and the pipe section shaped outer ring.

10. The transmission element according to claim 1 wherein contours of the pipe section shaped inner ring and the pipe section shaped outer ring intersect.

11. The transmission element according to claim 1 wherein an entire thickness of a wall of at least one of the plurality of pipe section shaped compression bodies where it is in contact with at least one of the pipe section shaped inner ring and the pipe section shaped outer ring is contained within a wall of at least one of the pipe section shaped inner ring and outer ring.

12. The transmission element according to claim 1 wherein at least one of the pipe section shaped inner ring, the pipe section shaped outer ring, and the plurality of pipe section shaped compression bodies are manufactured from an elastomer.

13. The transmission element according to claim 1, wherein the pipe section shaped inner ring, the pipe section shaped outer ring, and the plurality of pipe section shaped compression bodies are manufactured from one piece.

14. The transmission element according to claim 1, wherein at least one of the pipe section shaped inner ring and the pipe section shaped outer ring have a plurality of bars running in an axial direction, positioned around the pipe section shaped inner ring in between the plurality of pipe section shaped compression bodies.

15. The transmission element according to claim 14, wherein the plurality of bars are formed semi-circular in cross-section.

16. A mechanical coupling gear; comprising:
a first connector element;
a pipe section shaped outer ring connected with the first connector element;
a pipe section shaped inner ring within the pipe section shaped outer ring and axial parallel with the pipe section shaped outer ring;
a second connector element connected with the pipe section shaped inner ring; and
a plurality of pipe section shaped compression bodies arranged between the pipe section shaped inner ring and the pipe section shaped outer ring.
